(19) United States
(12) Patent Application Publication
(10) Pub. No.: US 2008/0191014 A1
(43) Pub. Date: Aug. 14, 2008

(54) Multifunctional card reader

(75) Inventor: Hsun-Lteh Chuang, Hsin Tien City (TW)

Correspondence Address: Troxell Law Office Pllc, Suite 1404, 5205 Leesburg Pike, Falls Church, VA, 22041, US

(73) Assignee: Heisei Electronics Co., Ltd.

(21) Appl. No.: 11/703,836

(22) Filed: Feb. 8, 2007

(51) Int. Cl. G06K 7/00

(52) U.S. Cl. 235/435

(57) ABSTRACT

The present invention provides a multifunctional card reader, in which an application procedure used by a user to use a card reader includes pre-operation, setting of required executable program and operating of data program. The setting of required executable program step of the application procedure is used when a user wants to open data stored in a memory card, thereby enabling the user to set the executable software program required to open the data, whereafter the user presses a button on the card reader, and the data stored in the memory card is opened using the preset software program. Moreover, the software program set to open the data can be reset to another software program required by the user to open the data, thereby achieving the objective of convenience of use for a user.

### BACKGROUND OF THE INVENTION

(a) Field of the Invention

The art of the present invention provides a multifunctional card reader, which enables a user to implement a setting of required executable program step of an application procedure to preselect a software program required by the user to open data stored in a memory card.

(b) Description of the Prior Art

A conventional card reader only allows single access to data stored in a memory card and copying to a computer, whereupon software on the computer is used to open the data. Accordingly, such a configuration causes inconvenience to the user.

Furthermore, the conventional card reader only enables a single type of software program to open the data stored in a memory card, and does not allow a user to reset to a software program the user requires to use to open the data, thereby resulting in inconvenience to the user. Hence, the prior art lacks practicability.

### SUMMARY OF THE INVENTION

The art of the present invention provides a multifunctional card reader, which enables a user to implement a setting of required executable program step of an application procedure to preselect a software program required by the user to open data stored in a memory card. After setting, a user needs only to press a button on a card reader, and data stored in the memory card is opened using the preset software program, moreover, the software set to open the data can be reset to another software program required by the user to open the data.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a system block diagram according to the present invention.

FIG. 2 shows a flow diagram according to the present invention.

FIG. 3 shows a first schematic elevational view of an embodiment according to the present invention.

FIG. 4 shows a second schematic elevational view of the embodiment according to the present invention.

### DETAILED DESCRIPTION OF THE PREFERRED EMBODIMENTS

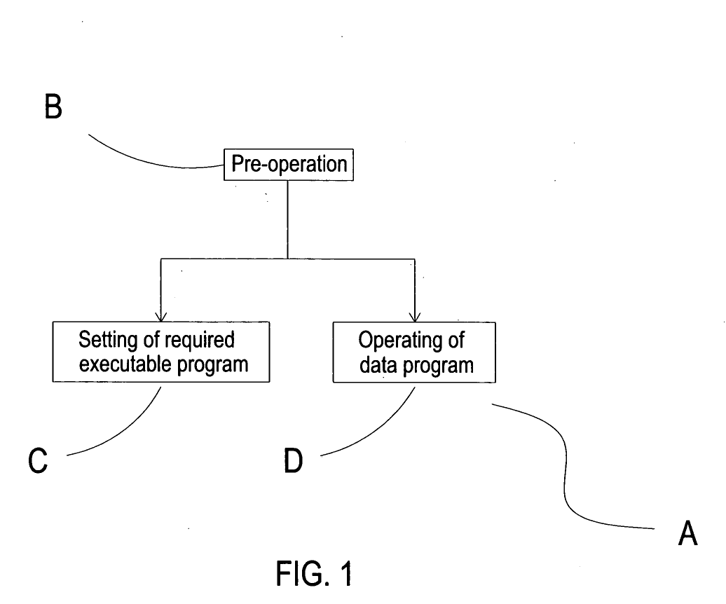

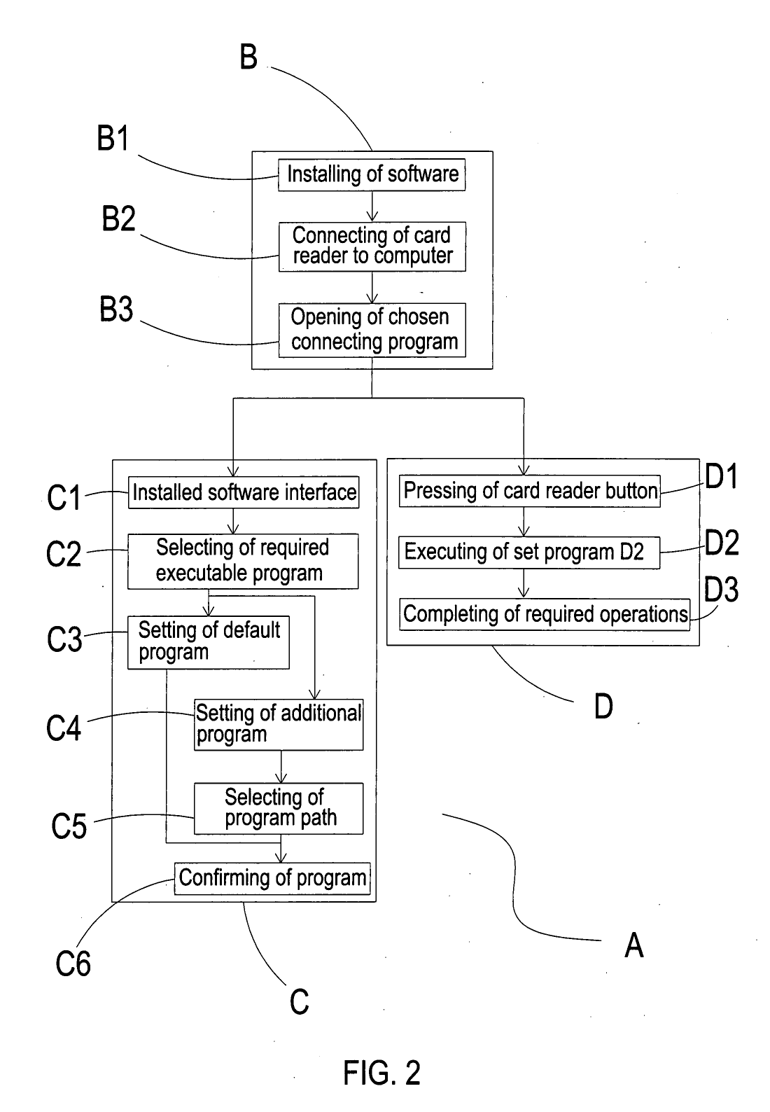

Referring to FIG. 1 and FIG. 2, the present invention provides a multifunctional card reader, wherein an application procedure A comprises pre-operation B, setting of required executable program C and an operating of data program D.

The pre-operation B step first implements a installing of software B1 step, after which a connecting of card reader to computer B2 operation is implemented, and then an opening of chosen connecting program B3 step. After the opening of chosen connecting program B3 step, then the setting of required executable program C step is executed.

The setting of required executable program C step first executes an installed software interface C1 operation, and then a selecting of required executable program C2 step is implemented. The selecting of required executable program C2 is divided into setting of default program C3 and setting of additional program C4. The setting of additional program C4 step requires implementing a selecting of program path C5 step, which is followed by a confirming of program C6 step, after completion of which then the application procedure A proceeds with the operating of data program D step.

The operating of data program D first requires a pressing of card reader button D1 step, whereafter an executing of set program D2 is executed, after completion of which is then followed by a completing of required operations D3 step, thereby achieving convenience of use for a user.

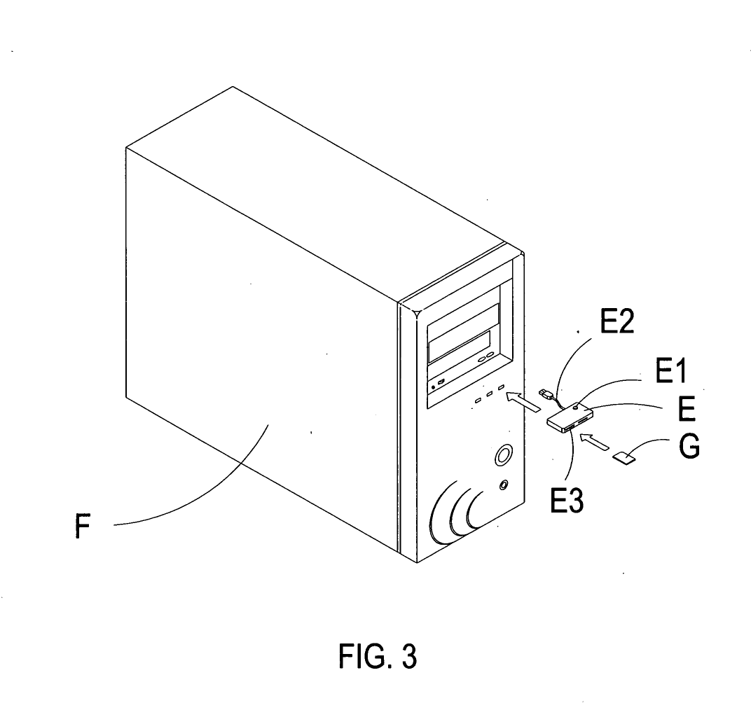

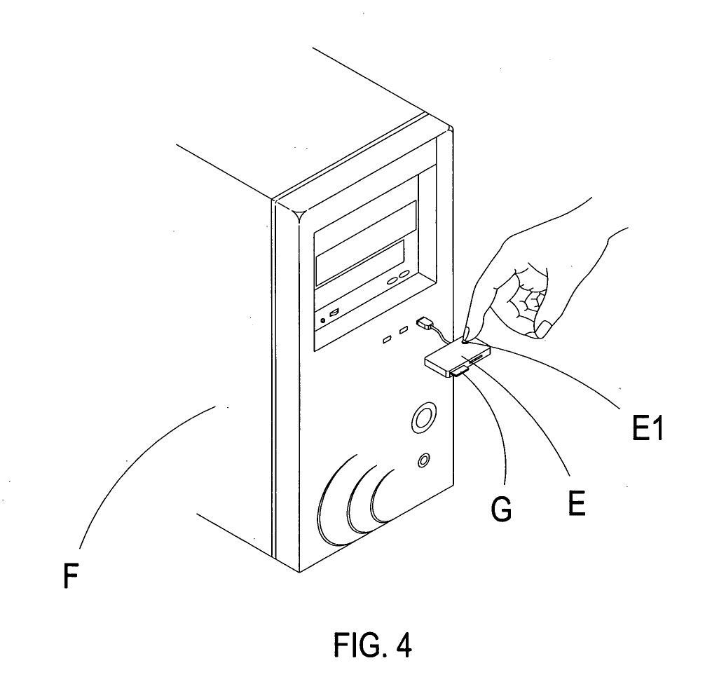

Referring to FIG. 2, FIG. 3 and FIG. 4, wherein an embodiment of the present invention provides a multifunctional card reader, wherein when a user wants to use a card reader E, then the pre-operation B step is first implemented, in which the pre-operation B step initially implements the installing of software B1 step, thereby installing built-in software of the card reader E to a computer F, and the software is used to function in coordination with the card reader E. Completion of the installing of software B1 step is followed by the connecting of card reader to computer B2, wherein a transmission line E2 on the card reader E is electrically connected to the computer F, after which a memory card G is inserted into an insertion slot E3 of the card reader E. After the connecting of card reader to computer B2 step, the card reader E activates software installed on the computer F, at which time the opening of chosen connecting program B3 step is implemented, which decides what software program to open. If it is the first use or the user wants to reset the software program required to open data, then the setting of required executable program C step of the application procedure A can be implemented.

When implementing the setting of required executable program C, then the installed software interface C1 is displayed on a monitor of the computer F, thereby enabling a user to implement the selecting of required executable program C2 step. The selecting of required executable program C2 is divided into the setting of default program C3 and the setting of additional program C4 step. Selecting the setting of default program C3 enables the user to directly select the indicated software program to open data stored in the memory card G, which is directly following by the confirming of program C6 step. Furthermore, if the setting of default program C3 step does not include the program required by the user to open data, then the setting of additional program C4 step can be selected. The setting of additional program C4 step enables the user to freely select the program required to open data stored in the memory card G by first implementing the selecting of program path C5 step and then the confirming of program C6 step. Furthermore, after completing the setting of required executable program C step, then the opening of chosen connecting program B3 step is implemented, followed by the operating of data program D step. The operating of data program D step first requires the pressing of card reader button D1 step, and if the user does not press a button E1 of the card reader E, then every 0.5 seconds the computer F senses whether or not the button E1 of the card reader E has been pressed. If the button E1 of the card reader E has been pressed, then the executing of set program D2 step is implemented, at which time data stored in the memory card G is opened using the set program. After the user has completed operations, then the completing of required operations D3 step is implemented.

The setting of required executable program C step when using the card reader E enables a user to freely set the software program required to open data stored in the memory card G, thereby achieving user convenience in using the card reader.

In order to better explicitly disclose advancement and practicability of the present invention, advantages of the present invention are listed below:

1. Facilitates use of the card reader E.

2. Convenient operation.

3. High practicability.

4. Provided with industrial competitiveness.

5. Provided with Commercial Utility Value

6. Provided with originality.

In conclusion, the present invention clearly complies with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A multifunctional card reader, wherein application procedure of a card reader comprises pre-operation, setting of required executable program and operating of data program; the pre-operation comprises installing of software, connecting of card reader to computer and opening of chosen connecting program; the setting of required executable program comprises an installed software interface and selecting of required executable program; the selecting of required executable program comprises setting of default program and setting of additional program; the setting of additional program further comprises selecting of program path, and after completing the selecting of program path and the setting of default program, then a confirming of program is implemented; the operating of data program comprises pressing of card reader button, executing of set program and completing of required operations;
wherein the setting of required executable program of the application procedure facilitates a user to freely set the software program required to open data stored in a memory card, thereby achieving objective of convenience of use for a user.

2. The multifunctional card reader according to claim 1, wherein an insertion slot of the card reader enables memory cards of various specifications to be inserted therein for use thereof; the card reader is further configured with a plurality of insertion slots.

3. The multifunctional card reader according to claim 1, wherein the memory card is a CF card (Compact Flash Memory Card), a MS card (Memory Stick Memory Card), a MMC card (Multimedia Memory Card) and related memory cards used to store data.
